(19) United States
(12) Patent Application Publication
(10) Pub. No.: US 2013/0145321 A1
(43) Pub. Date: Jun. 6, 2013

(54) INFORMATION PROCESSING APPARATUS, METHOD OF CONTROLLING DISPLAY AND STORAGE MEDIUM

(71) Applicants: Kensuke HORIUCHI, Kunitachi-shi (JP); Makito OGURA, Hino-shi (JP); Kenichi NAITO, Ome-shi (JP)

(72) Inventors: Kensuke HORIUCHI, Kunitachi-shi (JP); Makito OGURA, Hino-shi (JP); Kenichi NAITO, Ome-shi (JP)

(73) Assignee: KABUSHIKI KAISHA TOSHIBA, Tokyo (JP)

(21) Appl. No.: 13/564,620

(22) Filed: Aug. 1, 2012

(30) Foreign Application Priority Data
Dec. 2, 2011 (JP) 2011-264510

(51) Int. Cl. G06F 3/048; G06F 3/033

(52) U.S. Cl. 715/830; 715/810

(57) ABSTRACT

According to one embodiment, an information processing apparatus includes a first controller and a second controller. The first controller updates a display state of a list of images to collect a plurality of images of the contents including an identical attribute into a group image if a first operation is accepted. The second controller updates the display state of the list of images to unfold the plurality of images of the contents collected into the group image if a second operation is accepted.

### CROSS-REFERENCE TO RELATED APPLICATIONS

This application is based upon and claims the benefit of priority from prior Japanese Patent Application No. 2011-264510, filed Dec. 2, 2011; the entire contents of which are incorporated herein by reference.

### FIELD

Embodiments described herein relate generally to an information processing apparatus, a method of controlling display and storage medium.

### BACKGROUND

In recent years, an information processing apparatus, which can be driven by a battery and which is configured to be easily carried, for allowing the user to download (purchase) and browse digital book data (to be referred to as e-books hereinafter) via the Internet has begun to prevail.

Normally, e-books include image data on their book covers, and the information processing apparatus of the above type displays a list of purchased e-books, using the image data. From the images of the book covers displayed as a list, the user selects the image corresponding to the e-book he or she would like to read, and starts reading the selected e-book.

Most information processing apparatuses of this type have a relatively compact and low-profile housing as small as that which can be held by the user by one hand. Therefore, a display space required to display a list of cover images and to display the contents of an e-book is normally relatively narrow.

Thus, various mechanisms for efficiently displaying a plurality of images and the like have been proposed so far.

For example, books called magazines are issued periodically (for example, weekly or monthly). Also, most comic books are issued irregularly but continuously. The information processing apparatus used to browse e-books executes the following conventional screen control. That is, (1) lists of series e-books and independent e-books (such as novels which are concluded in one book) are displayed on different screens, and (2) series e-books are grouped to display representative images of groups on a top screen, and when one of representative images is selected, the current screen transits to another screen required to display a list of e-books in that group.

However, with the method (1), for example, series books are dispersed by sorting, and it is inconvenient to browse series books in turn. On the other hand, with the method (2), screen switching is required, and it is inconvenient when series books are to be browsed while referring to independent books.

For this reason, it is strongly demanded to efficiently make operations for series e-books and those for independent e-books using a single user interface without distinguishing series e-books and independent e-books from each other.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing the outer appearance of an information processing apparatus according to an embodiment.

FIG. 2 is an exemplary block diagram showing the system arrangement of the information processing apparatus according to the embodiment.

FIG. 3 is an exemplary view showing a display example of an e-book list by an e-book application program which runs on the information processing apparatus according to the embodiment.

FIG. 4 is an exemplary view for explaining a scroll condition which is decided based on a shelf width and a display area width in an e-book list display operation executed by the information processing apparatus according to the embodiment.

FIG. 5 is an exemplary view showing unfolding of a book group in the e-book list display operation executed by the information processing apparatus according to the embodiment.

FIG. 6 is an exemplary view showing folding of a book group in the e-book list display operation executed by the information processing apparatus according to the embodiment.

FIG. 7 is an exemplary view for explaining a change from a folded state to an unfolded state of a book group in the e-book list display operation executed by the information processing apparatus according to the embodiment.

FIG. 8 is an exemplary view for explaining a change from an unfolded state to a folded state of a book group in the e-book list display operation executed by the information processing apparatus according to the embodiment.

FIG. 9 is an exemplary view showing an example of formation of a blank space at the left end of a display area when a book group is changed from the unfolded state to the folded state to have an operation position as the center.

FIG. 10 is an exemplary view showing an example of formation of a blank space at the right end of the display area when a book group is changed from the unfolded state to the folded state to have an operation position as the center.

FIG. 11 is an exemplary first view (left end) for explaining a determination logic introduced to prevent any blank space from being formed at an end portion of the display area when a book group is changed from the unfolded state to the folded state in the e-book list display operation executed by the information processing apparatus according to the embodiment.

FIG. 12 is an exemplary second view (right end) for explaining a determination logic introduced to prevent any blank space from being formed at an end portion of the display area when a book group is changed from the unfolded state to the folded state in the e-book list display operation executed by the information processing apparatus according to the embodiment.

FIG. 13 is an exemplary flowchart showing the sequence of the determination logic introduced to prevent any blank space from being formed at an end portion of the display area when a book group is changed from the unfolded state to the folded state in the e-book list display operation executed by the information processing apparatus according to the embodiment.

### DETAILED DESCRIPTION

Various embodiments will be described hereinafter with reference to the accompanying drawings.

In general, according to one embodiment, an information processing apparatus includes a display and an input module. The display is configured to display a list of images representing contents. The input module is configured to accept an operation for a display area where the display displays the list of images. The display includes a first controller and a second controller. The first controller is configured to update a display state of the list of images to collect a plurality of images of the contents including an identical attribute into a group image if the input module accepts a first operation for positions on the display area where images of contents including the identical attribute are displayed side-by-side. The group image allows a user to identify that the contents comprising the identical attribute are grouped. The second controller is configured to update the display state of the list of images to unfold the plurality of images of the contents collected into the group image and including the identical attribute if the input module accepts a second operation for a position on the display area where the group image is displayed.

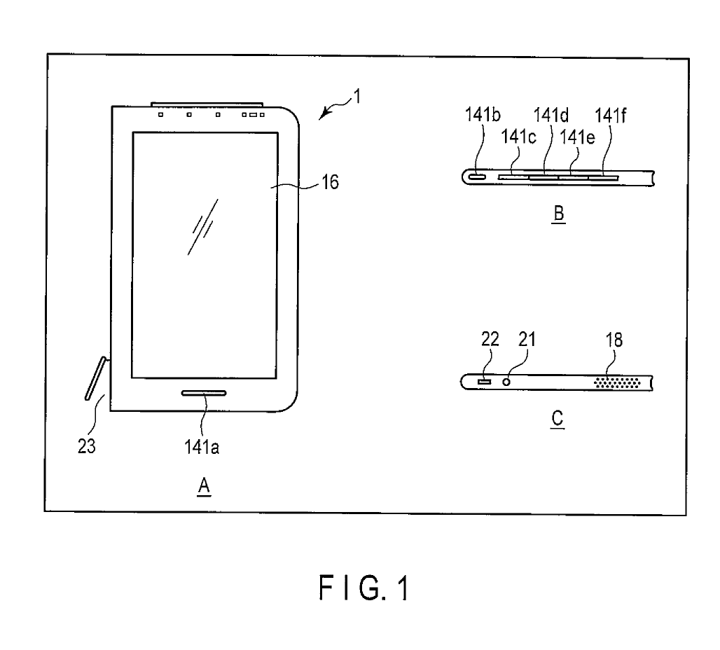

FIG. 1 is an exemplary view showing the outer appearance of an information processing apparatus 1 according to this embodiment. This information processing apparatus 1 is implemented as a portable terminal which allows the user to download and browse e-books via the Internet. In FIG. 1, “A” is a front view of the information processing apparatus 1, “B” is a top view of the information processing apparatus 1, and “C” is a bottom view of the information processing apparatus 1.

As shown in “A” of FIG. 1, a touch panel display 16 is arranged on a central portion of a front surface of a housing of the information processing apparatus 1. A home button 141a as one of various operation buttons is arranged on a surrounding portion of the touch panel display 16 and on a lower portion of the front surface of the housing. The home button 141a is used to return a display on the touch panel display 16 to an initial screen. Note that a slot 23 used to receive, for example, a MicroSD (Secure Digital) card (registered trademark) is arranged on the side surface of the housing. “A” of FIG. 1 shows a lid used to cover this slot 23. The information processing apparatus 1 includes a wireless communication function using, for example, Wi-Fi. With this wireless communication function, the information processing apparatus 1 allows the user to purchase, that is, to download e-books via the Internet.

As shown in “B” of FIG. 1, various operation buttons 141b to 141f are arranged on the top surface of the housing of the information processing apparatus 1. An operation button denoted by reference numeral 141b is a power button. The user turns on/off a power supply of the information processing apparatus by operating this power button 141b.

Furthermore, as shown in “C” of FIG. 1, a microUSB connector 22 used to connect a universal serial bus (USB) cable, a headphone jack 21 used to connect a headphone, and a loudspeaker 18 are arranged on the bottom surface of the housing of the information processing apparatus 1.

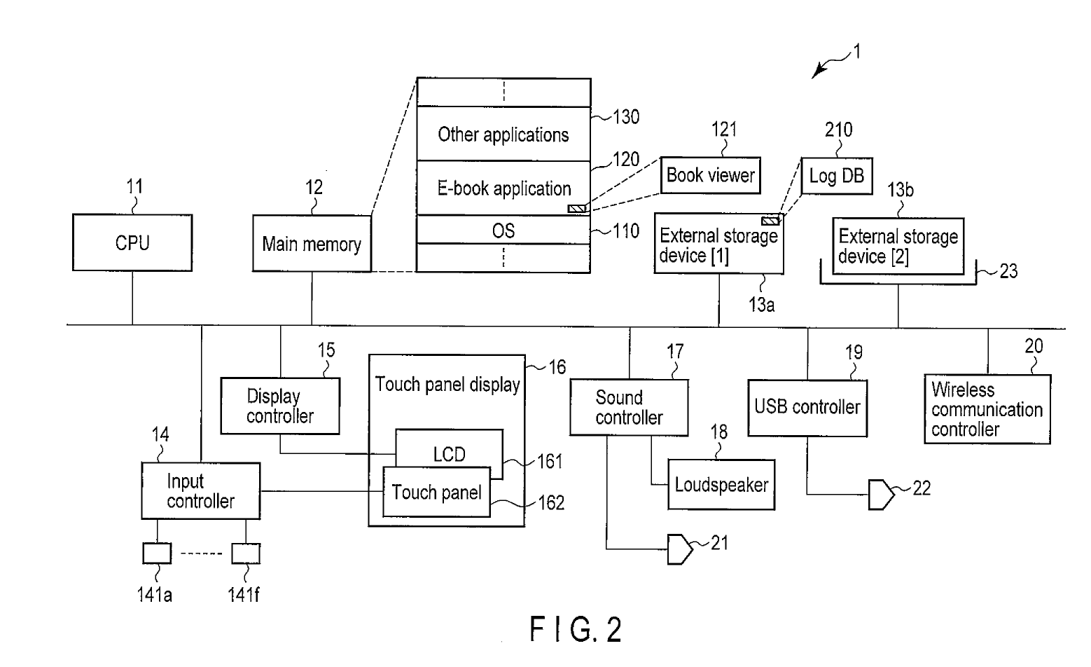

FIG. 2 is an exemplary block diagram showing the system arrangement of the information processing apparatus 1.

As shown in FIG. 2, the information processing apparatus 1 includes a central processing unit (CPU) 11, main memory 12, external storage device [1] 13a, input controller 14, display controller 15, touch panel display 16, sound controller 17, loudspeaker 18, USB controller 19, wireless communication controller 20, and the like.

The CPU 11 is a processor which controls the operation of the information processing apparatus 1. The CPU 11 loads various programs from the external storage device [1] 13a (for example, a flash memory) onto the main memory 12, and executes the loaded programs. An external storage device [2] 13b in FIG. 2 is a MicroSD card (registered trademark) inserted in the aforementioned slot 23. The external storage device [2] 13b is inserted in the slot 23 mainly for the purpose of extending an area for storing e-books. Also, the CPU 11 can also load programs stored in this external storage device [2] 13b onto the main memory 12, and can execute the loaded programs.

Various programs to be executed by the CPU 11 include an OS (Operating System) 110 for resource management, and an e-book application program 120 (to be described below), other application programs 130 and the like, which run on the OS 110. The e-book application program 120 includes a book viewer 121 required to browse e-books. Note that the book viewer 121 is included as one module of the e-book application program 120. However, in another aspect, the book viewer 121 may be installed as a program (one of other application programs 130) independently of the e-book application program 120.

The input controller 14 is a controller required to control data inputs by touch operations on the touch panel display 16 and those by operations of various operation buttons 141a to 141f. On the touch panel display 16, a liquid crystal display (LCD) 161 and touch panel 162 are built in. When the user makes a touch operation on the touch panel display 16, input information including a position on the touch panel 162 is output from the touch panel 162 to the input controller 14. The input controller 14 stores this input information in its own register, and generates an interrupt to notify the CPU 11 of the input information, thereby causing the CPU 11 to read the input information stored in the register. Then, occurrence of an event, that is, the touch operation on the touch panel display 16 is transferred to the OS 110.

Likewise, when the user operates each of various operation buttons 141a to 141f, the input controller 14 stores this input information in its own register, and generates an interrupt to notify the CPU 11 of the input information, thereby causing the CPU 11 to read the input information stored in the register. Thus, occurrence of an event, that is, the operation of each of various operation buttons 141a to 141f is transferred to the OS 110.

The OS 110 notifies the e-book application program 120, other application programs 130, and the like of occurrence of the transferred events.

On the other hand, the display controller 15 is a controller required to control an image display on the LCD 161 built in the touch panel display 16. The display controller 15 includes an accelerator which renders images to be displayed by various programs in place of the CPU 11.

The sound controller 17 is a sound source device. The sound controller 17 generates a sound signal corresponding to audio data to be played back, and outputs the sound signal to the loudspeaker 18. When a headphone is connected to the headphone jack 21, the sound controller 17 switches an output destination of the sound signal to the headphone jack 21.

The USB controller 19 is a module which controls communications with USB devices connected via the microUSB connector 22. The wireless communication controller 20 is a module which controls wireless communications.

The basic principle of display control executed by the e-book application program 120 which runs on the information processing apparatus 1 with the aforementioned arrangement will be described below.

The e-book application program 120 includes a function of allowing the user to purchase e-books, a function of displaying a list of purchased e-books, and a function of allowing the user to browse e-books (a function of controlling the book viewer 121). In this embodiment, the function of displaying the list of purchased e-books will be described in detail below.

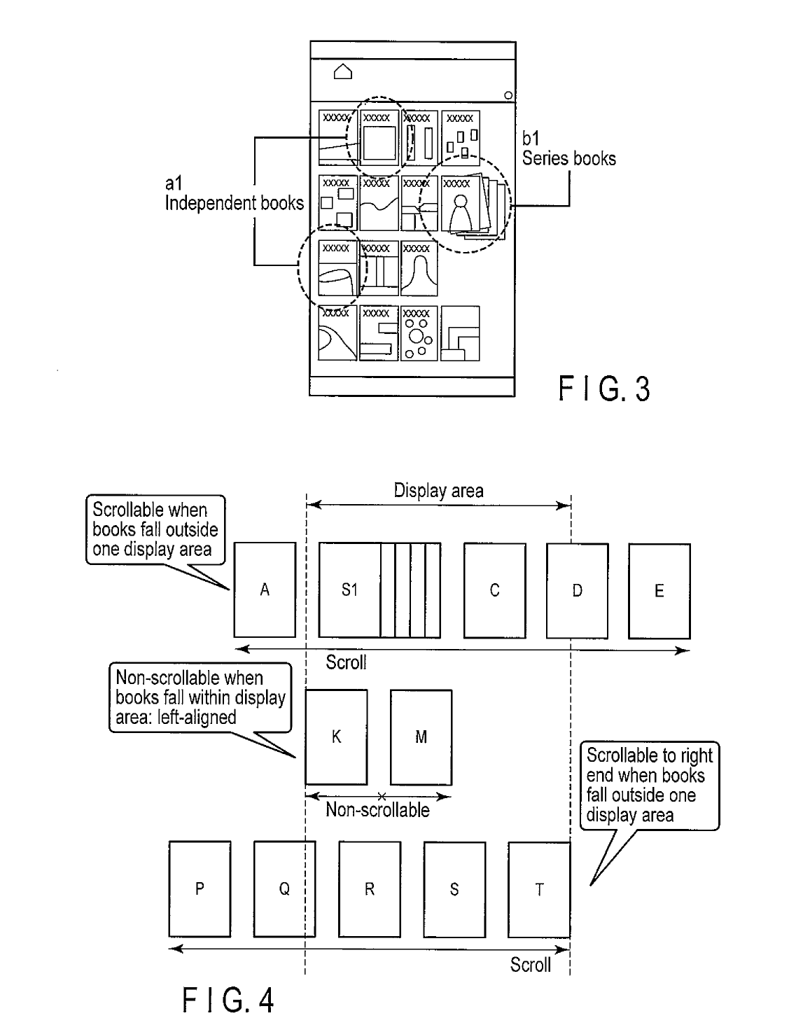

FIG. 3 is an exemplary view showing a display example of an e-book list by the e-book application program 120.

E-books to be handled by the e-book application program 120 are roughly classified into two types: “independent books” and “series books”. An independent book is one which is concluded in one book. On the other hand, series books are those having an identical title but different volumes/numbers. Magazines and comics are series books. Magazines include individual books having different dates of issue, such as “xx issue” although they have an identical title. Comics include individual books having different volumes/numbers like “Vol. xx” although they have an identical title. As shown in FIG. 3, the e-book application program 120 displays independent books (a1 in FIG. 3) and series e-books (b1 in FIG. 3) within a single screen. As for series books, a plurality of books which belong to an identical series are collected at one place. In this embodiment, this collection is called a “book group”. Books included in each book group are always those of an identical series, and independent books or books of another series are never included. Metadata of each e-book describes a book ID, title information, date of issue information, volume/number information, and the like. The e-book application program 120 groups books having identical title information as a book group.

The e-book application program 120 displays books (cover images) in a matrix pattern. The user can arbitrarily set a layout of books independently of independent books and series books, as if he or she were placing books on a bookshelf. The e-book application program 120 does not limit the number of books which can be laid out in each row. In this case, a length from the left side of a book at the left end to the right side of a book at the right end in each row will be referred to as “shelf width” hereinafter. The “shelf width” may be different for respective rows. The e-book application program 120 does not limit the number of rows (shelves). Hence, the book list which is displayed in the matrix pattern can be scrolled in both the vertical and horizontal directions.

A scroll condition decided based on the shelf width and a display area width will be described below with reference to FIG. 4.

When the shelf width is larger than the display area width, books can be scrolled in the horizontal direction. When the shelf width is equal to or smaller than the display area width, books cannot be scrolled. When books cannot be scrolled, the left end of the shelf is located at the left end of the display area, and the right end of the shelf is located on the left of the right end of the display area (left aligned). Even when books can be scrolled, the left end of the shelf is never located on the right of the left end of the display area, and the right end of the shelf is never located on the left of the right end of the display area.

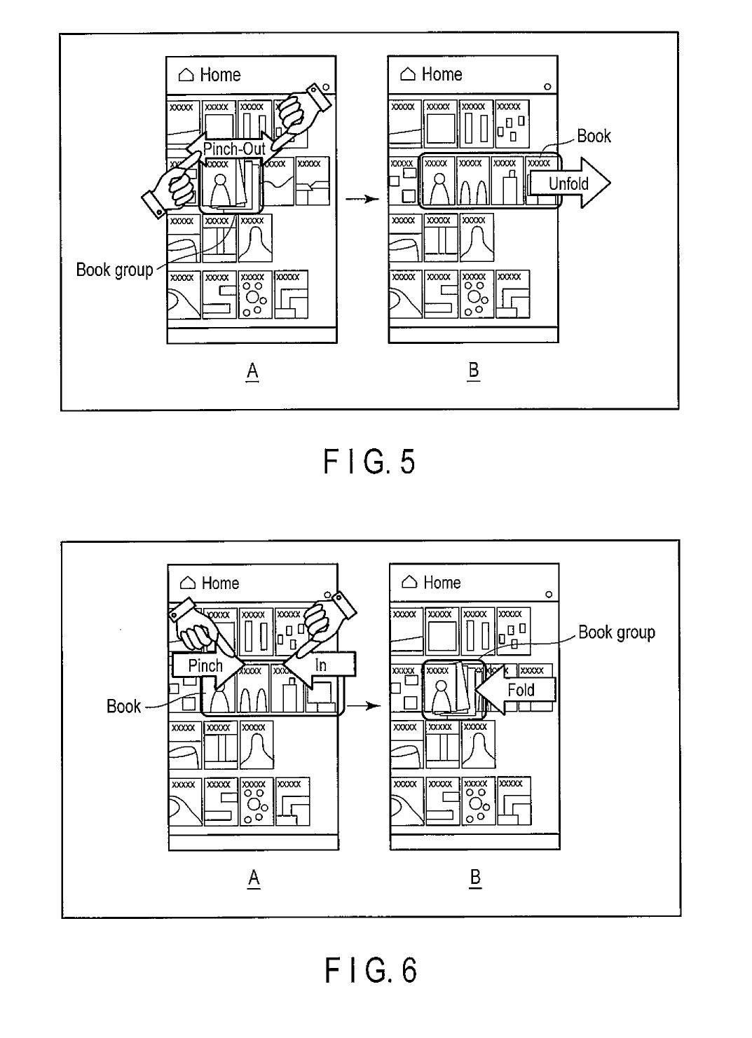

A book group as a collection of series books takes two states: “unfolded state” and “folded state”. FIG. 5 shows unfolding of the book group. FIG. 6 shows folding of the book group.

In the unfolded state, covers of all books which belong to an identical series can be browsed. On the other hand, in the folded state, only a cover of one book of those which belong to an identical series can be confirmed, and other books are expressed to be folded below that one book. Books in the book group are sorted in, for example, ascending or descending order of volume/number, and the left to right relationship in the unfolded state and the hierarchical relationship in the folded state are decided in that order. The sort order of the book group may be other than the order of volumes/numbers.

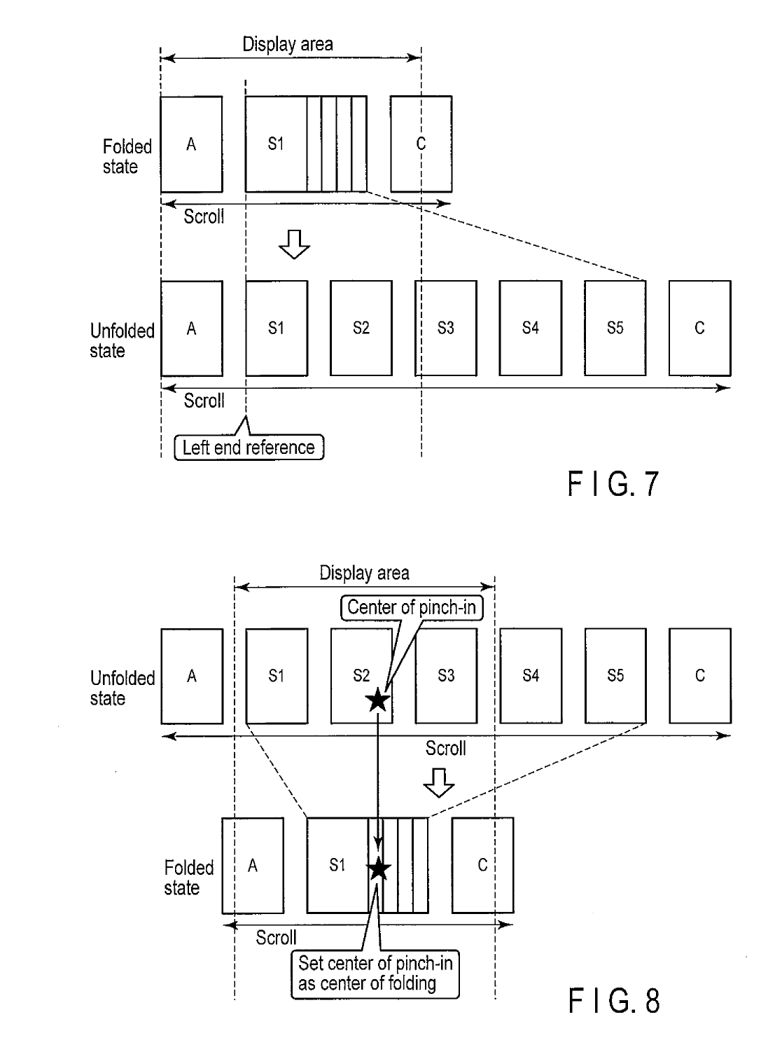

A change from the folded state to the unfolded state of the book group will be described below with reference to FIG. 7. When the user makes a pinch-out operation on the book group in the folded state, the book group changes to the unfolded state. The pinch-out operation is a sliding operation for separating two contact points away from each other on the touch panel display 16. The user can recognize the change to the unfolded state by an animation effect. However, the animation effect is not indispensable. An origin of the change to the unfolded state is the left side of a book at the left end of the book group in the folded state. Books other than that at the left end are unfolded to the right side according to the set order. An operation for changing the book group to the unfolded state is not limited to the pinch-out operation, and may be other operations such as tapping.

A change from the unfolded state to the folded state of the book group will be described below. As shown in FIG. 8, when the user makes a pinch-in operation on the book group in the unfolded state, that book group changes to the folded state. The pinch-in operation is a sliding operation for brining two contact points closer to each other on the touch panel display 16. The user can recognize the change to the folded state by an animation effect. However, the animation effect is not indispensable. Assume that a target upon changing to the folded state is the center of the pinch-in operation. The center of the horizontal width of the book group in the folded state is matched with the center of the pinch-in operation. An operation for changing the book group to the folded state is not limited to the pinch-in operation, but may be attained by other operations such as tapping. Also, there is a plurality of decision methods of the center of the pinch-in operation. For example, in one method, the center of coordinates of two points at the beginning of the pinch-in operation may be adopted.

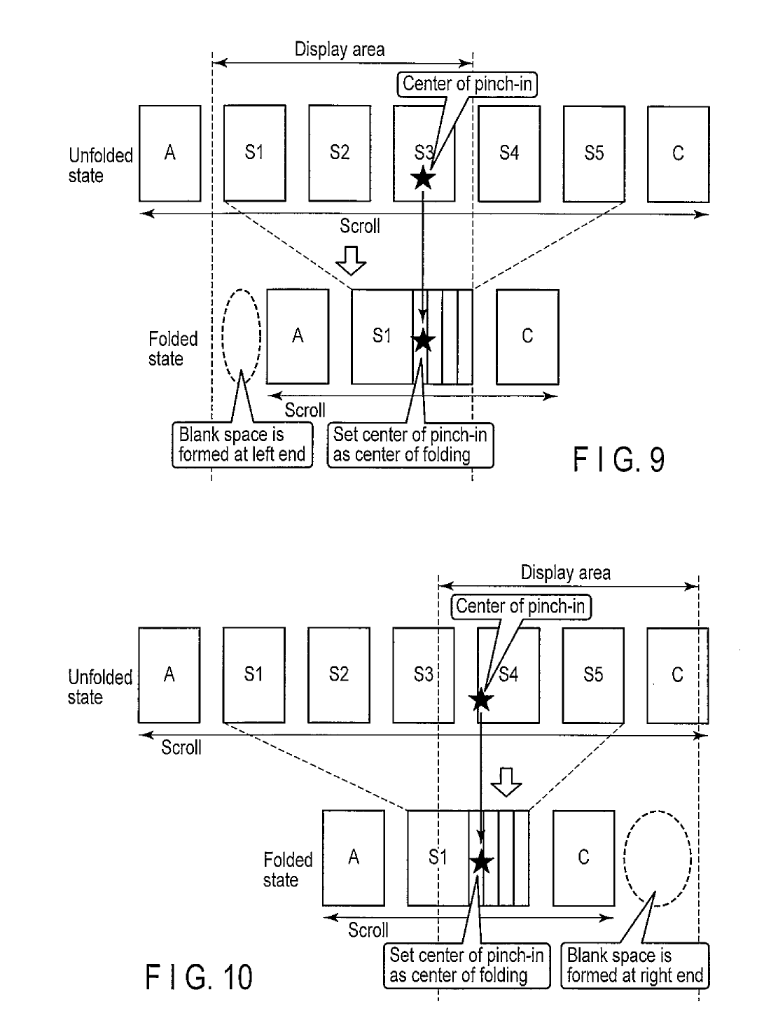

When the center of the pinch-in operation is always set as the target upon changing of the book group to the folded state, the aforementioned scroll condition decided based on the shelf width and display area width cannot be satisfied. For example, when a star position is adopted as the center of the pinch-in operation in the unfolded state shown in FIG. 9, a blank space is formed at the left end although the shelf width is larger than the display area width. Conversely, when a star position is adopted as the center of the pinch-in operation in the unfolded state shown in FIG. 10, a blank space is formed on the right side although the shelf width is larger than the display area width. Hence, the e-book application program 120 introduces the following determination logic so as to satisfy the scroll condition under such situations.

The e-book application program 120 calculates a shelf width (T) of a row as an operation target under the assumption that the book group is in the folded state. The shelf width is calculated from a margin between neighboring books, the width of each book, the width of the book group in the folded state, and the like. Next, the e-book application program 120 acquires a display area width (W). Since the display area width is different depending on whether the touch panel display 16 is used to have a Landscape or Portrait orientation, the e-book application program 120 acquires the display area width every time the display state of the book group is changed.

The e-book application program 120 compares the shelf width (T) and display area width (W). When the shelf width (T) is smaller than the display area width (W), the e-book application program 120 sets the center of folding so that the left side of a book at the left end in an identical row matches the left side of the display area when the book group to be operated changes to the folded state.

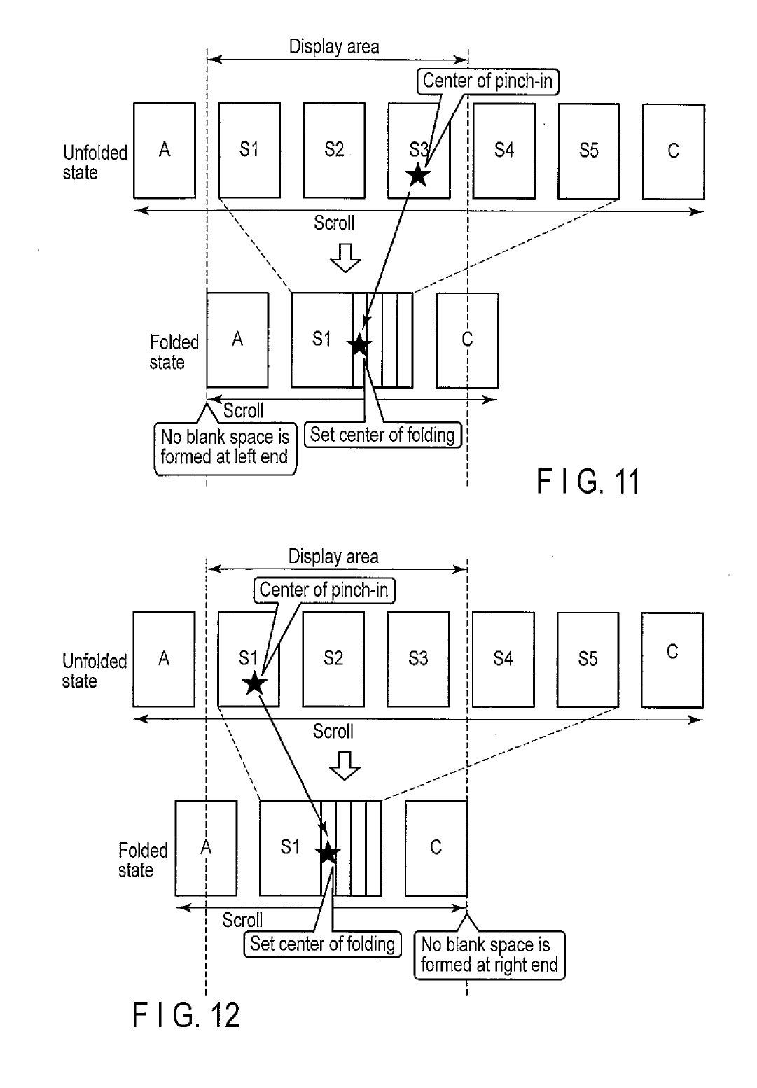

On the other hand, when the shelf width (T) is equal to or larger than the display area width (W), the e-book application program 120 temporarily decides the center of the pinch-in operation as that of folding. The e-book application program 120 calculates the position of a book at the left end in an identical row based on the temporarily decided center of folding under the assumption that the book group to be operated is in the folded state. At this time, when the left side of the book at the left end is located on the right of that of the display area, the e-book application program 120 sets the center of folding so that the left side of the book at the left end matches that of the display area, as shown in FIG. 11.

When the left side of the book at the left end is located on the left of that of the display area, the e-book application program 120 subsequently calculates the position of a book at the right end in an identical row under the assumption that the book group to be operated is in the folded state. At this time, when the right side of the book at the right end is located on the left of that of the display area, the e-book application program 120 sets the center of folding so that the right side of the book at the right end matches that of the display area, as shown in FIG. 12.

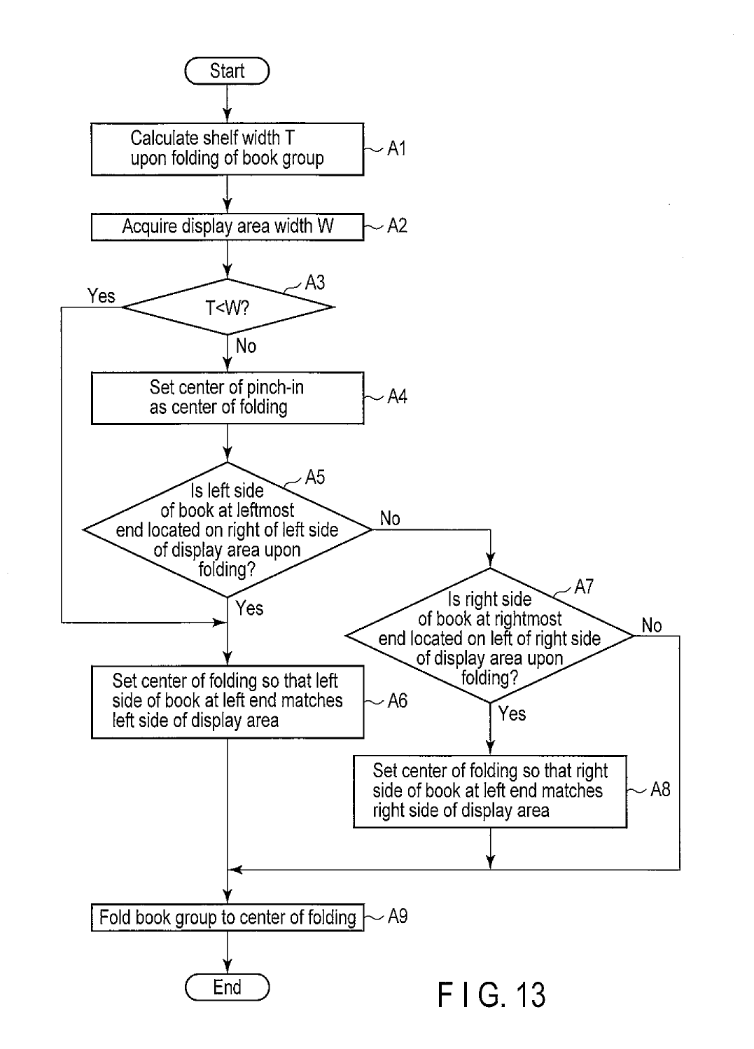

FIG. 13 is an exemplary flowchart showing the sequence of the determination logic introduced by the e-book application program 120, so as to prevent a blank space from being formed at an end portion of the display area when the book group is changed from the unfolded state to the folded state.

The e-book application program 120 calculates the shelf width upon folding of the book group (block A1), and acquires the display area width (block A2). The e-book application program 120 compares the shelf width and display area width (block A3). If the shelf width is smaller than the display area width (YES in block A3), the e-book application program 120 sets the center of folding, so that the left side of a book at the left end matches that of the display area (block A6).

On the other hand, if the shelf width is equal to or larger than the display area (NO in block A3), the e-book application program 120 temporarily sets the center of the pinch-in operation as that of folding (block A4). The e-book application program 120 checks whether or not the left side of a book at the leftmost end is located on the right of that of the display area at the time of folding (block A5). If the left side of the book at the leftmost end is located on the right of that of the display area (YES in block A5), the e-book application program 120 sets the center of folding so that the left side of the book at the left end matches that of the display area (block A6).

If the left side of the book at the leftmost end is not located on the right of that of the display area, that is, it is located on the left of that of the display area (NO in block A5), the e-book application program 120 checks whether or not the right side of a book at the rightmost end is located on the left of that of the display area (block A7). If the right side of the book at the rightmost end is located on the left of that of the display area (YES in block A7), the e-book application program 120 sets the center of folding so that the right side of the book at the right end matches that of the display area (block A8). Note that if the right side of a book at the rightmost end is not located on the left of that of the display area, that is, it is located on the right of that of the display area (NO in block A7), the setting in block A4 is used.

As described above, according to the information processing apparatus 1, the following effects can be provided. That is, (1) series books are collected to form book groups, thus providing appearances equivalent to independent books, (2) by collecting series books to form book groups, a plurality of books which belong to an identical series can be prevented from being dispersed in the bookshelf, thus facilitating management, and (3) by comparing and evaluating the shelf width and display area width after folding before the book group changes from the unfolded state to the folded state, the center of folding, which can satisfy a scroll state based on the application specification, can be set, and an unnatural scroll state which may occur only during the change to the folded state can be excluded.

That is, the information processing apparatus 1 allows to efficiently make operations for series e-books and those for independent e-books using a single user interface.

Note that the book viewer 121 records, for each book, a browsing start date, a page displayed when the user interrupted browsing, and the like in a log database 210 as browsing log information. When the information processing apparatus 1 is powered on by operating the power button 141b, the e-book application program 120 displays an e-book list using this browsing log information recorded in the log database 210, so that the most recently browsed book at the previous power ON timing is located at, for example, the central portion of the display area. At this time, the e-book application program 120 controls not to form any blank space at the left or right side of the display area by introducing the aforementioned determination logic.

Operation control processing of this embodiment can be implemented by software (program). By installing and executing this software in a normal computer via a computer readable storage medium that stores the software, the same effects as in this embodiment can be easily attained.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display configured to display a list of images representing contents; and
an input module configured to accept an operation for a display area where the display displays the list of images,
wherein the display comprises:
a first controller configured to update a display state of the list of images to collect a plurality of images of the contents comprising an identical attribute into a group image if the input module accepts a first operation for positions on the display area where images of contents comprising the identical attribute are displayed side-by-side, the group image allowing a user to identify that the contents comprising the identical attribute are grouped; and
a second controller configured to update the display state of the list of images to unfold the plurality of images of the contents collected into the group image and comprising the identical attribute if the input module accepts a second operation for a position on the display area where the group image is displayed.

2. The apparatus of claim 1, wherein the first controller is configured to decide a display position of the group image on the display area by evaluating the display state of the list of images after the plurality of images of the contents comprising the identical attribute are collected into the group image.

3. The apparatus of claim 2, wherein:
the list of images is scrollable in an arrangement direction of the images so that a first number of images are displayed on the display area; and
the first controller is configured to decide the display position of the group image so as not to form blank space at a first end portion on the display area in a state where an image is scrolled from a second end side of the display area.

4. The apparatus of claim 2, wherein the first controller is configured to decide the display position of the group image so as not to form blank space between a start image and a second end of the display area or between a last image and a first end of the display area.

5. The apparatus of claim 4, wherein the first controller is configured to decide the display position of the group image so as not to form blank space between the start image and the second end of the display area when a number of images after the plurality of images of the contents collected into the group image and comprising the identical attribute is less than the number of images that are allowed to be displayed on the display area.

6. The apparatus of claim 1, wherein:
the contents comprise e-books; and
the first controller and the second controller are configured to determine that e-books comprising identical title information in metadata of the e-books are the contents comprising the identical attribute.

7. The apparatus of claim 6, wherein the group image comprises an image representing a state where the e-books comprising the identical title information are folded in an order of dates of issue to display an e-book comprising a latest date of issue information in the metadata or an e-book comprising an oldest date of issue information at a top position, a cover of the e-book comprising the latest date of issue information or the e-book comprising the oldest date of issue information displayed.

8. The apparatus of claim 7, wherein the group image is selected from an image representing a folded state in descending order of date of issue information and an image representing a folded state in ascending order of date of issue information based on an order of arrangement when the e-books comprising the identical title information are unfolded and displayed in a list.

9. The apparatus of claim 1, wherein the display further comprises a resume module configured to display the list of images so that an image of a content most recently used during a previous active period is displayed at a first position on the display area at a power ON timing.

10. The apparatus of claim 1, wherein:
the input module comprises a touch panel on a display surface of a display device;
the first operation comprises a pinch-in operation for bringing two contact points closer to each other on the touch panel; and
the second operation comprises a pinch-out operation for separating two contact points away from each other on the touch panel.

11. A method of controlling display for an information processing apparatus, the method comprising:
displaying a list of images representing contents;
accepting an operation for a display area where the list of images is displayed;
updating a display state of the list of images to collect a plurality of images of the contents comprising an identical attribute into a group image when a first operation for positions on the display area where images of contents comprising the identical attribute are displayed side-by-side is accepted, the group image allowing a user to identify that the contents comprising the identical attribute are grouped; and
updating the display state of the list of images to unfold the plurality of images of the contents collected into the group image and comprising the identical attribute if a second operation for a position on the display area where the group image is displayed is accepted.

12. A computer-readable, non-transitory storage medium having stored thereon a computer program executable by a computer, the computer program controlling the computer to function as:
a display configured to display a list of images representing contents; and
an input module configured to accept an operation for a display area where the display displays the list of images,
wherein the display comprises:
a first controller configured to update a display state of the list of images to collect a plurality of images of the contents comprising an identical attribute into a group image when the input module accepts a first operation for positions on the display area where images of contents comprising the identical attribute are displayed side-by-side, the group image allowing a user to identify that the contents comprising the identical attribute are grouped; and
a second controller configured to update the display state of the list of images to unfold the plurality of images of the contents collected into the group image and comprising the identical attribute if the input module accepts a second operation for a position on the display area where the group image is displayed.
